(19) United States
(12) Patent Application Publication
(10) Pub. No.: US 2026/0339577 A1
(43) Pub. Date: Oct. 29, 2026

(54) PRINT SETTING CUSTOMIZATION OF PRINTER DRIVER

(71) Applicant: Hewlett-Packard Development Company, L.P., Spring, TX (US)

(72) Inventors: Sohye KIM, Seongnam Si (KR); Sangmin LEE, Seongnam Si (KR); Junyoung CHOI, Seongnam Si (KR)

(21) Appl. No.: 19/116,058

(22) PCT Filed: Mar. 23, 2023
(86) PCT No.: PCT/US2023/016061

§ 371 Date: Mar. 27, 2025

(30) Foreign Application Priority Data
Sep. 29, 2022 (KR) 10-2022-0123907

(51) Int. Cl. G06F 3/12

(52) U.S. Cl. CPC G06F 3/1205; G06F 3/1238; G06F 3/1255; G06F 3/1257; G06F 3/1285

(57) ABSTRACT

A method for user account-specific management of a printer driver can include verifying a user account associated with a printer driver installed in a host device, and determining, for a printing feature supported by the printer driver, a configuration thereof useable by the user account. The method can include indicating, on a user interface device of the host device, the configuration of the printing feature. The printer driver can include a plurality of user accounts associable therewith including the first user account, and for each of the plurality of user accounts, configurations of the printing feature supported by the printer driver can be customized.

### BACKGROUND

There exist many different types of image forming apparatuses, including dedicated printers, scanners, photocopiers, facsimile machines, etc., and also multi-function products (MFPs). An MFP acts as an all-in-one solution to provide a combination of, for example, print, photocopy, scan, and fax functions.

An image forming apparatus may be connected to a host device in which a printer driver is installed for control of a printing feature of the image forming apparatus. The host device may use one universal printer driver (UPD) to perform such printing feature control for a plurality of image forming apparatuses that are network-connected thereto in a local or remote manner.

### BRIEF DESCRIPTION OF THE DRAWINGS

FIG. 1 is a diagram conceptually illustrating a configuration of an example host device consistent with the disclosure.

FIG. 2 is a diagram illustratively showing an example account-specific printing feature and permission information repository consistent with the disclosure.

FIG. 3 is a diagram illustratively showing an example printing feature-specific configuration repository consistent with the disclosure.

FIG. 4 is an example flow diagram illustratively showing an example method for user account-specific management of an example printer driver consistent with the disclosure.

FIG. 5 is an example flow diagram illustratively showing the operation of FIG. 4 for determining a configuration of a printing feature consistent with the disclosure.

FIG. 6 is an example flow diagram illustratively showing example operations for adding a new configuration of a printing feature consistent with the disclosure.

FIG. 7 is an example flow diagram illustratively showing example operations for modifying a configuration of a printing feature consistent with the disclosure.

FIG. 8 IS AN EXAMPLE FLOW DIAGRAM ILLUSTRATIVELY SHOWING EXAMPLE operations for converting a user account logged into the example printer driver consistent with the disclosure.

FIGS. 9A to 9E show example interfaces for example printing features supported by the example printer driver and customization of configurations thereof consistent with the disclosure.

FIG. 10 is a schematic illustration of a computer readable recording medium including example instructions consistent with the disclosure.

### DETAILED DESCRIPTION

A printer driver is a program that serves to have a print job delivered from an application of a host device, e.g., a computer device, to an image forming apparatus by converting the print job into instructions that are interpretable by the image forming apparatus and transferring the instructions to the image forming apparatus. The printer driver can be a printer driver specific to a type of image forming apparatus or a universal printer driver (UPD) that supports single-driver usage across a plurality of image forming apparatuses.

The printer driver may be installed in the host device for control of an image forming apparatus by supporting a user account log-in function. This allows generation of a plurality of user accounts, each of which is also referred to as a log-in account or an account. Further, for each user account, the printer driver may have an associated configuration and be used in association therewith. Thus, the printer driver may be utilized by a user with the multiple accounts such that the user may log into the printer driver with his/her desired user account on an as-needed basis and then use the image forming apparatus through the printer driver. In an example where the UPD is involved, the user may log into the UPD with his/her user account and then select which image forming apparatus to use in the UPD as his/her intended printer model.

Moreover, the printer driver may support a number of printing features related to the image forming apparatus. Examples of the supported printing features include a watermark feature, a preset printing option feature, a custom paper size feature, a special page feature, and the like. The user may utilize the printer driver, e.g., via an application, supported by the printer driver, to configure a setting of a printing feature supported by the printer driver and to employ the setting for carrying out a print job. For example, when the printer driver supports the watermark feature, the user may configure, in a customized manner, the watermark feature with details, e, g., detailed setting values, for use in the print job performed with the printer driver. Example details may include values indicating where a watermark is to be arranged, its size, its angle, a font to be applied thereto, and the like. The customized details may be stored as one configuration of the watermark feature and repeatedly used. Further, for each printing feature supported by the printer driver, a number of configurations may be created, stored, and then used. In an example where there are a number of watermark forms available for the watermark feature, the user may create, for each of the forms, a respective configuration for use of the watermark feature.

Various examples of the present disclosure provide for supporting user account-specific printing feature management by which configurations of a printing feature of a printer driver may be generated, used, and shared in a manner specific to individual user accounts. For each of the generated configurations of the printing feature, an access permission such as a read/write permission may be granted to a user account other than that for which the configuration is generated. In addition, a function may be provided to convert a user account of the printer driver, depending on a network environment to which the host device is connected, e.g., to another user account that corresponds to the connected network environment, which may improve a user experience.

In some examples, there is provided a method for user account-specific management of a printer driver. The method may include verifying a user account associated with a printer driver installed in a host device and determining, for a printing feature supported by the printer driver, a configuration thereof which is useable by the user account. The method can include indicating, on a user interface device of the host device, the configuration of the printing feature. The printer driver may have a plurality of user accounts that are associable therewith. For each of the plurality user accounts, configurations of the printing feature supported by the printer driver may be customizable. Thus, the printer driver may support logging in thereto with any of the plurality of user accounts and may allow user account-specific customization of the printing feature into its configurations for storage and use. In particular, as intended or desired by a user with the multiple accounts granted their respective access permissions, the user may utilize the account-specific customized printing feature.

Various terms used in the present disclosure are chosen from a terminology of commonly used terms in consideration of their function herein, which may be understood differently depending on an intention of a person skilled in the art, a precedent case, or an emerging new technology. In specific instances, some terms are ascribed their meanings as set forth in detail in the detailed description. Accordingly, the terms used herein are to be defined consistently with their meanings in the context of the present disclosure, rather than simply by their names.

The terms “comprising,” “including,” “having,” “containing,” etc. are used herein when specifying the presence of the elements listed thereafter. Unless otherwise indicated, these terms and variations thereof are not meant to exclude the presence or addition of other elements.

As used herein, the ordinal terms “first,” “second,” and so forth are meant to identify several similar elements. Unless otherwise specified, such terms are not intended to impose limitations, e.g., a particular order of these elements or of their use, but rather are used merely for referring to multiple elements separately. For example, an element may be referred to in an example with the term “first” while the same element may be referred to in another example with a different ordinal number such as “second” or “third.” In such examples, such ordinal terms are not to limit the scope of the present disclosure. Also, the use of the term “and/or” in a list of multiple elements is inclusive of all possible combinations of the listed items, including any one of a plurality of the items.

The term “image forming job” as used herein may encompass any of a variety of image-related jobs that involve an operation of forming an image and/or other processing operations, e.g., generation, storage, and/or transfer of an image file. The term “job” as used herein may encompass a chain of processes that facilitate an image forming job, as well as the image forming job per se. The expression “an image forming job performed by an image forming apparatus” may indicate a job related to printing, photocopying, scanning, facsimile, storage, transmission, coating, etc. Other types of jobs are also contemplated.

The term “image forming apparatus” as used herein may encompass any of a variety of devices, such as a printer, a scanner, a facsimile machine, an MFP, a display device, and the like, that are capable of performing an image forming job. In some examples, an image forming apparatus may be a two-dimensional (2D) or three-dimensional (3D) image forming apparatus. Such image forming apparatus may provide various additional functions, as well as basic ones, for example, print, photocopy, and scan functions.

The terms “electronic device,” “electronic apparatus,” or “user device” as used herein may refer to any information processing device, such as, for example, a computer, a laptop, a table PC, a mobile telephone terminal, etc., that may be used by a user.

The terms “host device” may mean a device that is connectable with an image forming apparatus to control a variety of functions of the image forming apparatus. For example, a host device may include any of an electronic device, an electronic apparatus, a user device, and the like that can be connected with an image forming apparatus in a wireless or wired manner.

Each of the terms “unit,” “module,” “engine”, and the like as used herein may refer to a unit to process a function or operation, which may be implemented as a hardware component, e.g., a processor or a circuit, a software component for execution by the hardware component, and/or a combination thereof.

Certain examples of the present disclosure will now be described in detail with reference to the accompanying drawings. The present disclosure may, however, be embodied in many different forms and should not be construed as limited to the examples set forth herein; rather, these examples are given in order to provide a better understanding of the scope of the present disclosure. It is contemplated that some of the individual features described in one of the drawings may be implemented independently from each other or in combination.

These and other features of the examples will become apparent from the following detailed description taken in conjunction with the accompanying drawings.

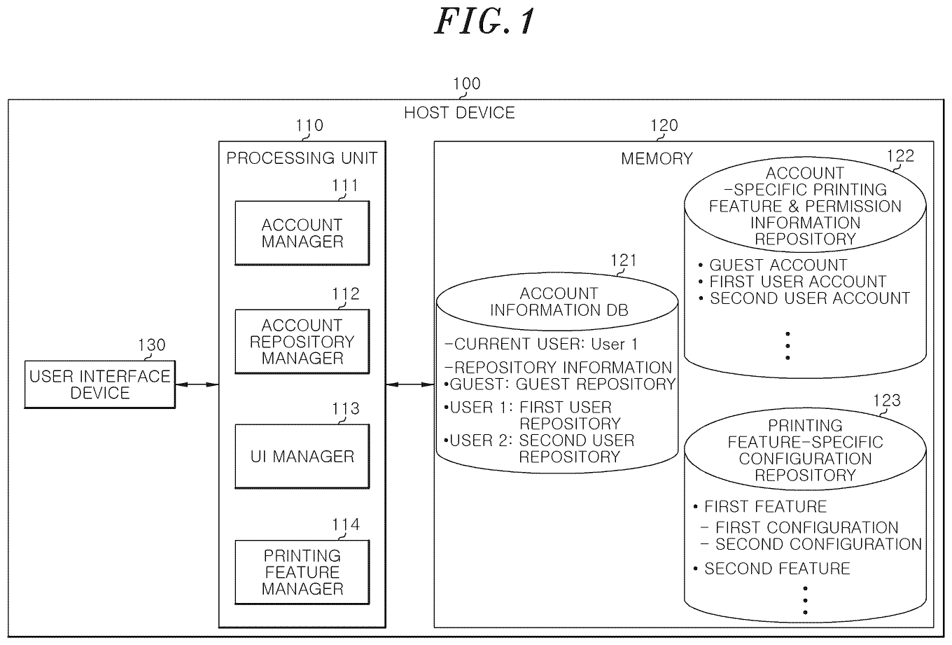

FIG. 1 is a diagram conceptually illustrating a configuration of an example host device 100 consistent with the disclosure.

Referring to FIG. 1, an example host device 100 may include a processing unit 110, a memory 120, and a user interface device 130. Other configurations of the host device 100 are also contemplated. In some examples, the host device 100 may also include an additional component, such as a power supply unit to supply power to the above-mentioned components, a communications unit to communicate with external entities, etc. In some examples, the host device 100 may include some of, but not all of, the components shown in FIG. 1. Further, the host device 100 may not be a single device, but may be include a plurality of interconnected devices.

The processing unit 110 may control the overall functionality of the host device 100. For example, the processing unit 110 may be implemented with a central processing unit (CPU), a graphics processing unit (GPU), or other processing circuitry to perform some or all functions of the host device 100. For example, the processing unit 110 may execute instructions stored in the memory 120. The processing unit 110 may also read other information stored in the memory 120. In addition, the processing unit 110 may store new information in the memory 120 and may update some information stored in the memory 120. For example, the processing unit 110 may obtain from the memory 120 information used to control the host device 100 or may store such information in the memory 120.

The processing unit 110 may include an account manager 111, an account repository manager 112, a user interface (UI) manager 113, and a printing feature manager 114. In this regard, each of the managers 111, 112, 113, and 114 refers to an element that performs a certain operation which is suitable for processing by an information processing device such as the host device. In other words, each of the managers 111, 112, 113, and 114 can be a unit that processes a function or operation and may be implemented as a hardware component, e.g., a processor or a circuit, a software component for execution by the hardware component, and/or a combination thereof. The function or operation may not be performed by that specific unit of the illustrated information processing device. The managers may not necessarily physically separate from one another and various managers may be combined into a single or multiple modules. For example, the processing unit 110 may be implemented as a component of a printer driver that is installed in the host device to control and perform a function of the printer driver.

The account manager 111 can manage a procedure for logging into and out of the printer driver. If a user logs into the printer driver with a given user account, then the account manager 111 can deliver information regarding the user account to the account repository manager 112 to make a request for user setup according to which the printer driver is to be used with the user account. If the user logs out of the printer driver, the account manager 111 can send to the account repository manager 112 a request to invalidate the setup, e.g., to release the user account from serving as a current user account of the printer driver.

As used herein, the phrase “a user account is associated with a printer driver” can include using the user's specific user account to log the user into the printer driver and using a guest account, also referred to as a common account, e.g., an account shared by two or more individuals, to utilize the printer driver. In an example, the guest account may request entering of a password, etc. In another example, the guest account may include a default non-password-protected account with which to utilize the printer driver without such login process. Further details thereof are set forth below with respect to the relevant operations.

The printer driver may be logged into with a user account which is different from that used in logging into the host device or other electronic device where the printer driver is installed. For instance, these two user accounts can be separate from each other, one for the host device and one for the printer driver. In some examples, the user may launch and use the host device by logging into the host device with the user account therefor and may then use a number of applications installed in the host device, for example, the printer driver, by logging into the printer driver with the user account therefor.

In some examples, the user may create a plurality of user accounts and use, on an as-needed basis, a certain one of the plurality of user accounts for logging into the printer driver. For example, the user may generate user accounts for business use and private use, respectively, and create, for each of the accounts, its associated different setting of the printer driver.

The account repository manager 112 can use an account information database (DB) 121 to set and manage user accounts associable with the printer driver and to manage a mapping of repositories to their respective pieces of information regarding printing features and permissions for application to the individual accounts. When receiving a request for user setup, together with information regarding a user account logged into the printer driver, the account repository manager 112 can set, based on the received user setup request, in the account information DB 121, the user account currently associated with the printer driver. Further, the account repository manager 112 can check if there exists a printing feature and permission information repository to be referenced when the printing feature of the print driver is provided with respect to the currently associated user account. If there is not any such repository, the account repository manager 112 can generate, within an account-specific printing feature and permission information repository 122, a printing feature and permission information repository to be referenced for the user account. In response, the account repository manager 112 can store, in the account information DB 121, a location of where the generated repository is to be referenced in the account-specific printing feature and permission information repository 122.

The UI manager 113 can generate, modify, and manage a configuration of a printing feature of the printer driver. For instance, the UI manager 113 may allow the user to customize as desired and use a configuration of one of the printing features supported by the printer driver. For example, the UI manager 113 can indicate, on the user interface device 130 of the host device 100, a user interface (UI) through which to receive the user's input including data to be used for the configuration of the printing feature, such as individual setting values for the configuration, user account-specific access permissions therefor, etc. Upon receipt of the input, the UI manager 113 can deliver, to the printing feature manager 114, the data included in the received input so that the printing feature manager 114 may generate, and make available in the printer driver, the configuration of the printing feature. Further, the UI manager 113 may operate to read, from a printing feature-specific configuration repository 123 of the memory 120, configurations of the printing feature that are available to the user through the user account currently associated with the printer driver and to indicate these configurations on an interface of the printer driver or the like.

The printing feature manager 114 can generate and manage the individual printing features supported by the printer driver. For each of the printing features, the printing feature manager 114 can generate the user's desired configuration. In response, the printing feature manager 114 can store and manage, in the printing feature-specific configuration repository 123, the generated configuration for use by the printer driver.

The memory 120 may include a computer-readable storage medium that stores data in a non-transitory form. Thus, the memory 120 may be implemented with Random Access Memory (RAM), Read-Only Memory (ROM), or other type of storage medium. The memory 120 may have stored therein a variety of information, for example, a set of instructions that are to be executed by the processing unit 110.

The memory 120 may have stored therein certain information for use by an example method and system for providing customization of a printing feature supported by the print driver. In some examples, the memory 120 may include the account information DB 121, the account-specific printing feature and permission information repository 122, and the printing feature-specific configuration repository 123. Accordingly, for each of the plurality of user accounts associable with the printer driver, configurations of the printing feature supported by the printer driver may be customized and stored, in association with that user account, within the memory of the host device. Based on reading of the configurations therefrom, the printer driver may perform operations of user account-specific management by the printer driver. This will be described in detail below.

The account information DB 121 can include current user information, e.g., information regarding the user account currently associated with the printer driver, and repository information, e.g., information regarding locations of the account-specific printing feature and permission information repository 122 that are to be referenced for the individual respective user accounts. In the example of FIG. 1, when the user logs into the printer driver with a user account indicated as “User 1,” then the account information DB may have set therein the user account as a current user. The account information DB 121 can include information indicating that a first user repository in the account-specific printing feature and permission information repository 122 may be referenced to retrieve information regarding a printing feature and a permission that are available to the user account “User 1” from the printer driver.

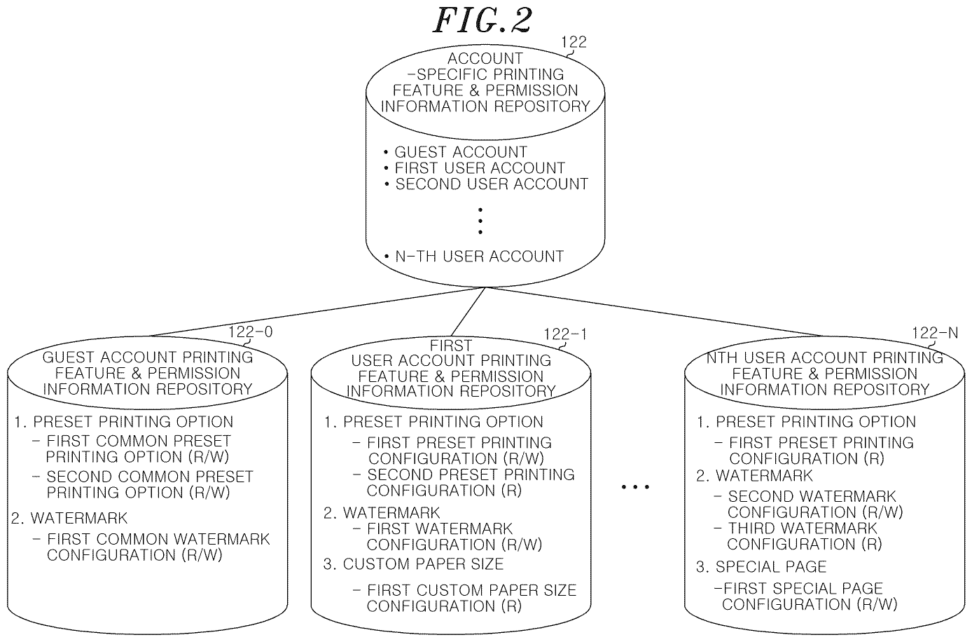

In the account-specific printing feature and permission information repository 122, there may include information related to usage of a printing feature of the printer driver for each of the individual user accounts. Further details of the account-specific printing feature and permission information repository 122 are described with respect to FIG. 2. The information stored in the account-specific printing feature and permission information repository 122 may include information regarding: a printing feature(s) available to that user account; a configuration(s) of each printing feature, for example, a detailed setting value of the configuration of the printing feature; and a permission for each configuration. In an example where the plurality of user accounts is associable with the printer driver, the account-specific printing feature and permission information repository 122 may have stored therein information regarding a printing feature(s) available to each of the user accounts, a configuration(s) of each printing feature, and a permission for each configuration.

FIG. 2 is a diagram illustratively showing an example account-specific printing feature and permission information repository 122 consistent with the disclosure. The example of FIG. 2 is illustrated with a number of printing features supported by the printer driver, including a preset printing option feature, a watermark feature, a custom paper size feature, and a special page feature, and with a number of accounts registered as using the printer driver, including a guest account and a first to a n-th user accounts. As shown, a guest account printing feature and permission information repository 122-0 has stored therein information indicating that: the preset printing option feature and the watermark feature are available to the guest account; the preset printing option feature has a first common preset printing configuration and a second common preset printing configuration that are useable by the guest account; and the watermark feature has a first common watermark configuration that is useable by the guest account. For example, the configurations useable by the guest account can be common configurations that may be used in common by all of the accounts. In some examples, the guest account printing feature and permission information repository 122-0 has also stored therein information regarding permissions for the individual respective configurations. For example, the stored permission information can indicate, for each of the configurations, whether this account has a read-only permission or a read/write permission. As such, when the printer driver is in use in association with the guest account, the processing unit 110, e.g., the account repository manager 112, may reference the guest account printing feature and permission information repository 122-0 to acquire the information regarding the printing features available to the guest account, the configurations of the individual printing features, and the permissions for the configurations.

Similarly, as described with respect to the example of FIG. 2, each of a first to a n-th user account printing feature and permission information repository 122-1, . . . , 122-n can have stored therein information regarding a printing feature(s) available to a respective one of the first to the n-th user accounts, a configuration(s) of each printing feature, and a permission for each configuration. For example, the first user account may use a first preset printing configuration and have a read/write permission therefor. Further, the first user account may use a second preset printing configuration while having a read-only permission therefor, e.g., without a permission to modify a setting value of the configuration. In some examples, these user accounts may use a common configuration of each printing feature, e.g., a configuration thereof that is useable by the guest account.

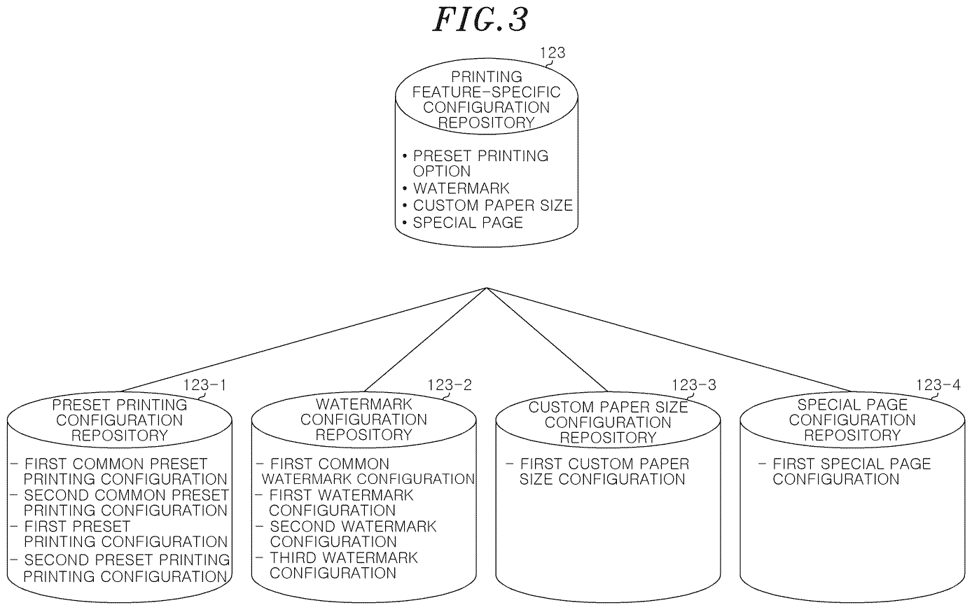

Referring back to FIG. 1, the printing feature-specific configuration repository 123 can have stored therein details, e.g., setting values, of common and customized configurations for each of the printing features supported by the printer driver. Further details of the printing feature-specific configuration repository 122 are described with respect to FIG. 3.

FIG. 3 is a diagram illustratively showing an example printing feature-specific configuration repository 123 consistent with the disclosure. In the example of FIG. 3, the printer driver supports printing features including, for instance, the preset printing option feature, the watermark feature, the custom paper size feature, and the special page feature. The printer driver, e.g., the UI manager 113 of the processing unit 110, may reference the printing feature-specific configuration repository 123 to retrieve a printing feature-specific configuration that may be used in common by all of the user accounts and a printing feature-specific customized configuration that is created by the user. As shown, in the example of FIG. 3, a preset printing configuration repository 123-1 may have stored therein detailed setting values of each configuration that is applicable for the preset printing option feature, such as values indicating: whether double-sided printing is to be performed, a printing paper size, etc. Further, a watermark configuration repository 123-2 may have stored therein detailed setting values of each configuration that is applicable for the watermark feature, such as values indicating: where a watermark is to be arranged, its horizontal and vertical offsets, a message to be indicated, an angle at which the message is to be indicated, a font to be applied therefor, etc. In some examples, a custom paper size configuration repository 123-3 may have stored therein detailed setting values of each configuration that is applicable for the custom paper size feature, such as values indicating a width and a height of a paper sheet, among others. A special page configuration repository 123-4 may have stored therein detailed setting values of each configuration that is applicable for the special page feature, such as values indicating: whether a cover page is to be used, a printing option to be applied to a particular page, etc.

Referring again to FIG. 1, the user interface device 130 can provide an input and/or output interface to the user of the host device 100. In some examples, the user interface device 130 may include a display device that serves as an output interface to provide or output the printer driver interface and a status, a certain message, an installed application, etc., of the host device 100. The display device may be a touch screen or other configuration. In some examples, the user interface device 130 may include an input interface device to receive various inputs from the user. For example, the user may select his/her desired image forming job or select among various options related to the image forming job, through such input interface device. In some examples, the user may launch, through the input interface device, an application installed in the host device 100. The user may also use the input interface device to control the printer driver to perform its function. Some examples of the input interface device may include a keyboard, a keypad, a physical button, a touch pad, a touch screen, and other types of devices that can receive user inputs.

In some examples, the input and the output interface devices included in the user interface device 130 may be implemented as separate components or may be combined in a single component. For example, the user interface device 150 may be implemented as a touch screen, which is operable both as the output interface device to provide an output to the user and as the input interface device to receive an input from the user.

Some example methods for user account-specific management of a print driver will be discussed below. These example methods may be performed by the host device 100. For example, the printer driver may be installed in the host device 100 and implemented with the processing unit 110, the memory 120, and the user interface device 130 to perform the methods. For ease of description, it may be generally assumed that the example methods are performed by the host device 100.

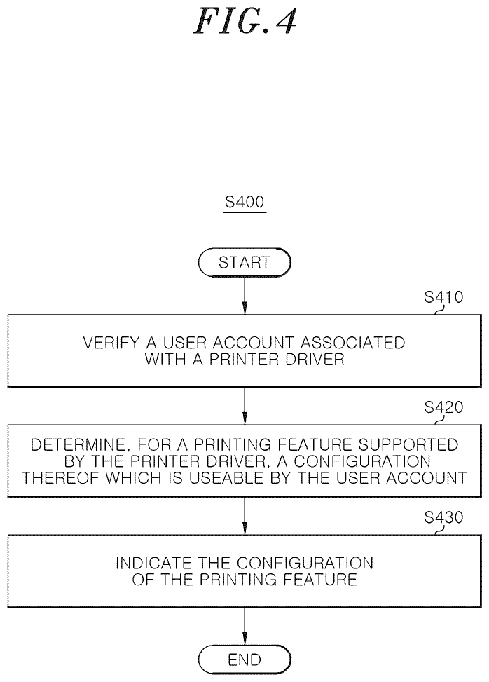

FIG. 4 is an example flow diagram illustratively showing an example method S400 for user account-specific management of an example printer driver consistent with the disclosure.

The method S400 can include an operation S410 of verifying a user account associated with a printer driver that is installed in the host device 100. In some examples where the printer driver has a plurality of user accounts associable therewith, if a user logs into the printer driver with a user account, e.g., a first user account, which is given for use of an image forming apparatus, the host device 100 can verify the user account associated with the printer driver, e.g., the user account that is currently logged into the printer driver. For example, when the account manager 111 updates the account information DB 121, the host device 100 may reference the updated account information DB 121 to verify the user account that is currently using the printer driver.

The method S400 can include an operation S420 of determining, for a printing feature supported by the printer driver, its configuration which is useable by the user account. In an example where the user account verified at S410 is the first user account, a printing feature(s) of the printer driver which is(are) available to the first user account, together with a configuration(s) of each printing feature, may be acquired from the memory 120 and in particular from the account information DB 121, the account-specific printing feature and permission information repository 122, and the printing feature-specific configuration repository 123.

The method S400 can include an operation S430 of indicating, on the user interface device 130 of the host device 100, the configuration(s) of the acquired printing feature(s). For example, when the user has logged into the printer driver with the given user account, he/she may check what configurations of each printing feature supported by the printer driver are useable by the user account, such as detailed setting values of a particular watermark, detailed setting values of a particular preset printing option, etc., and select therefrom his/her desired configuration to use that printing feature of the printer driver. Further, there may also be indicated thereon information regarding what permission the user has for the configuration of the printing feature, for example, whether the permission is a read-only permission or a read/write permission.

If logging in thereto with another user account, the user may be provided with a configuration of a printing feature corresponding to this user account. If the guest account is used, which does not involve the log-in process, the user may be provided with a configuration of a printing feature corresponding to the guest account. As such, for each of the plurality of user accounts with which the printer driver is associable, a corresponding customized printing feature may be provided.

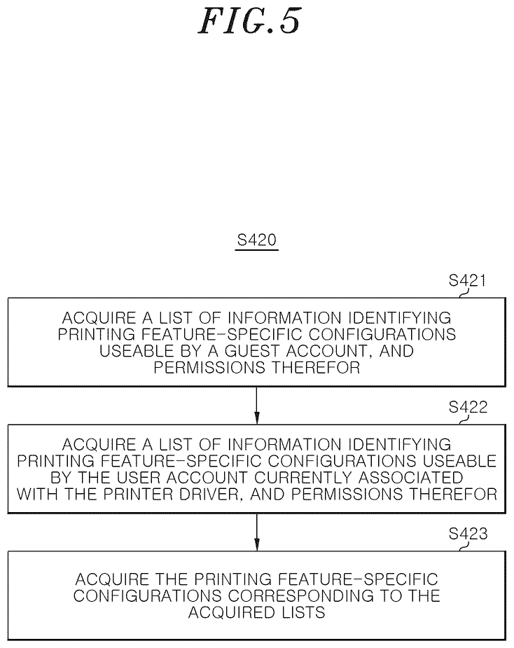

FIG. 5 is an example flow diagram illustratively showing the operation of FIG. 4 for determining a configuration of a printing feature consistent with the disclosure.

The operation S420 can include an operation S421 of acquiring a list of information identifying printing feature-specific configurations useable by the guest account and permissions therefor. In some examples, the guest account includes an account with which to use the printer driver without it being logged into the printer driver. In other words, the guest account, with which the printer driver may be used, can be an account shared by a number of users, rather than an account customized for a particular user. Thus, the guest account printing feature and permission information repository 122-0 may be referenced, as in the example of FIG. 2, to acquire a list of information identifying printing features available to the guest account, configurations of each printing feature, and a permission for each configuration.

The operation S420 can include an operation S422 of acquiring a list of information identifying printing feature-specific configurations useable by the user account that is currently associated with the printer driver and permissions therefor. For instance, if the first user account is currently associated with the printer driver, then the first user account printing feature and permission information repository 122-1 may be referenced, as in the example of FIG. 2, to acquire a list of information identifying printing features available to the first user account, configurations of each printing feature, and a permission for each configuration.

The operation S420 can include an operation S423 of acquiring the printing feature-specific configurations corresponding to the acquired lists. In an example where the first user account is currently associated with the printer driver, the list of printing feature-specific configurations that are useable by the guest account and the list of printing feature-specific configurations that are useable by the first user account can be acquired at the operations S421 and S422, respectively. Thus, the printing feature-specific configuration repository 123 may be referenced to acquire details of each of the configurations included in each of the lists. In the example of FIG. 2, the following may be available to the first user account: the first preset printing configuration, the second preset printing configuration, the first watermark configuration, and the first custom paper size configuration. In some examples, the following may be available to the guest account: the first common preset printing configuration, the second common preset printing configuration, and the first common watermark configuration. Accordingly, via the printer driver, the first user account may employ the printing feature-specific configurations available to the first user account and those available to the guest account. The host device 100 may acquire detailed setting values of the printing feature-specific configurations by referencing the printing feature-specific configuration repository 123 as described with respect to FIGS. 1 and 3.

With the acquired printing feature-specific configurations indicated on, for example an interface of the printer driver, the user may check, for his/her currently logged-in account, a customized printing feature and its configuration such as a setting value therefor and may utilize the feature. In some instances, there may also be indicated thereon information regarding what permission the user has for the configuration of the printing feature, for example, whether the permission is a read-only permission or a read/write permission.

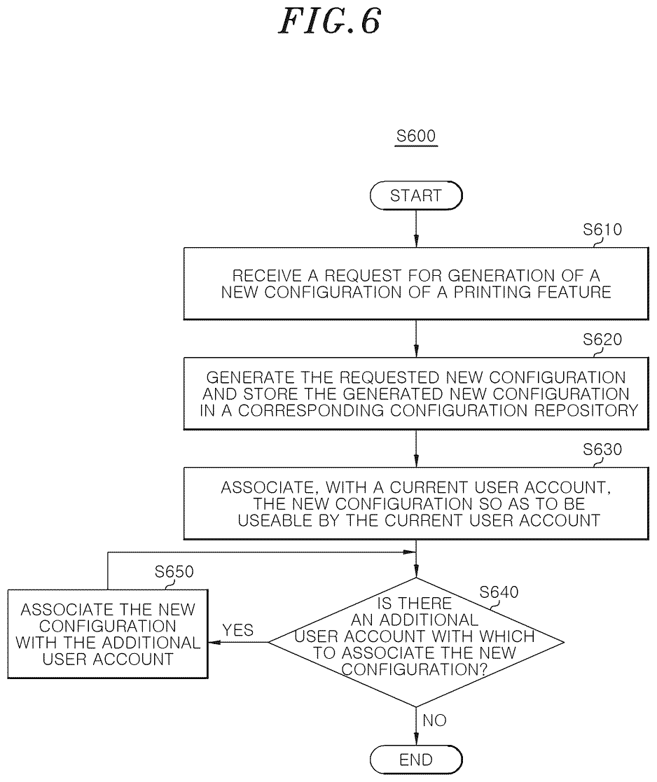

FIG. 6 is an example flow diagram illustratively showing example operations for adding a new configuration of a printing feature consistent with the disclosure.

FIG. 6 shows a method S600 as an example of the printing feature configuration addition, according to which the user may create, as needed, a customized configuration to be applied when employing a printing feature supported by the printer driver.

The method S600 can include an operation S610 of receiving a request for generation of a new configuration of a printing feature. In an example where the UI manager 113 of the host device 100 indicates a UI of the printer driver on the UI device 130, the user may create a configuration of his/her desired printing feature by specifying a customized setting value therefor via the UI. For example, in order to make a request for generation of a new configuration of the custom paper size feature supported by the printer driver, the user may specify a setting value therefor such as a new width and height of a paper sheet.

The method S600 can include an operation S620 of generating the new configuration of the printing feature as requested and storing the generated new configuration in a corresponding configuration repository. In some examples, the memory 120 has stored therein, such as in the printing feature-specific configuration repository 123, the configurations that are applicable to the individual printing features and that may be referenced by the printer driver, as described above with respect to FIGS. 1 and 3. For example, if the user creates a new configuration of the custom paper size feature, then the new configuration may be stored, with its setting value customized by the user, in the custom paper size configuration repository 123-3 and referenced for use by the printer driver.

The method S600 can include an operation S630 of associating, with the user's current user account, the generated new configuration so as to be useable by the current user account. For example, upon the request for generation of the new configuration of the printing feature being made from the user account associated with the printer driver, the host device records, in a repository that corresponds to the user account and that is included in the account-specific printing feature and permission information repository 122, information indicating that the generated new configuration is useable and information regarding a permission therefor. In response, the user account may employ the generated new configuration. For example, the permission information may indicate that the user is granted a read/write permission on his/her created new configuration. Other examples of the permission are also possible. In an example where the user creates a new configuration of the custom paper size feature while staying logged into the printer driver with the first user account, the newly generated custom paper size configuration may be added, into the list retained in the first user account printing feature and permission information repository 122-1, along with its matching information regarding a read/write (R/W) permission therefor.

The method S600 may include an operation S640 of verifying whether there exists an additional user account with which to associate the new configuration. When creating the new configuration of the printing feature, the user may share his/her created new configuration with a user account other than his/her user account so that this new configuration may be employed even when the printer driver is logged into with the other user account. For example, the new configuration generation request may include data that specifies the other user account's permission to access the new configuration.

If the additional user account to be associated exists, the method S600 may include an operation S650 of associating the new configuration with the user account. For instance, when the new configuration generation request includes information regarding the additional user account with which to share the new configuration and information regarding a permission to be granted therefor, the host device 100 can record, in a repository that corresponds to the user account and that is included in the account-specific printing feature and permission information repository 122, information indicating that the generated configuration is useable and information regarding a permission therefor. As such, the new configuration of the printing feature can be accessible when the printer driver is logged into with a user account with which it is allowed to be shared, whereas such information is not accessible when the printer driver is logged into with a user account which is not added as its sharer. The operations S640 and S650 may be repeated for all user accounts with which the new configuration is to be shared.

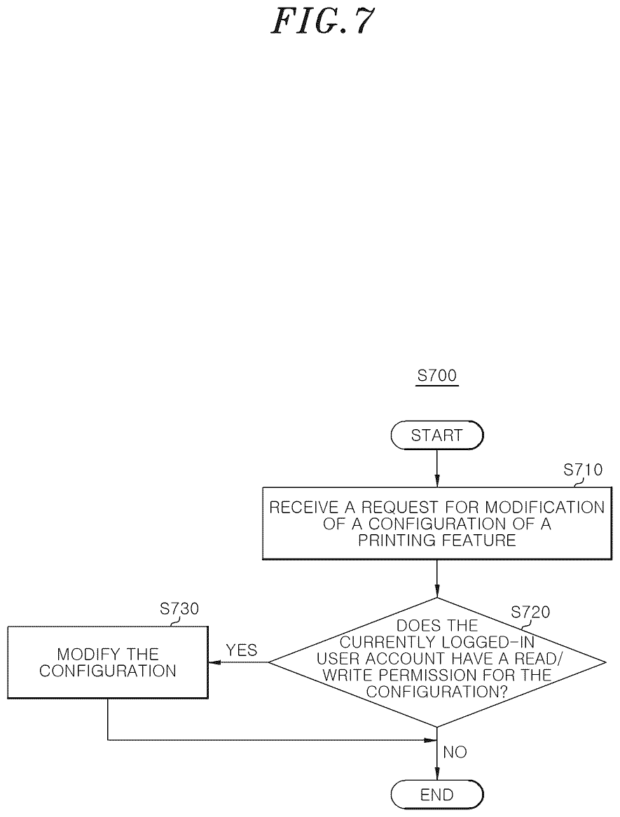

FIG. 7 is an example flow diagram illustratively showing example operations for modifying a configuration of a printing feature consistent with the disclosure.

FIG. 7 shows a method S700 as an example of the printing feature configuration modification, according to which the user may alter, as needed, a configuration to be applied when employing a printing feature supported by the printer driver.

The method S700 can include an operation S710 of receiving a request for modification of a configuration of a printing feature. In an example where the user logs into the printer driver with a given user account, the user may enter, via an interface of the printer driver, an input to request modification of a configuration of a given printing feature by changing some setting values for the configuration. For example, with regard to a certain configuration of the watermark feature, a request may be made to modify a location where a watermark is to be indicated.

The method S700 can include an operation S720 of verifying whether the user account that is currently logged into the printer driver, e.g., the user account with which the modification is requested, has a read/write permission for the configuration that is requested to be modified. It is noted above that each user account may be granted a permission, such as a read-only permission or a read/write permission, for a configuration of a printing feature. Thus, if the configuration of the printing feature is requested to be modified, but the user account merely has a read-only permission therefor, the modification request may not be accepted. If the configuration of the printing feature is requested to be modified and the user account has a write permission therefor, the configuration may be modified according to the request. For instance, in order for the configuration to be modified, its setting value stored in its corresponding printing feature-specific configuration repository is modified and stored back therein. Then, when reference is made for the configuration, the modified setting value is returned.

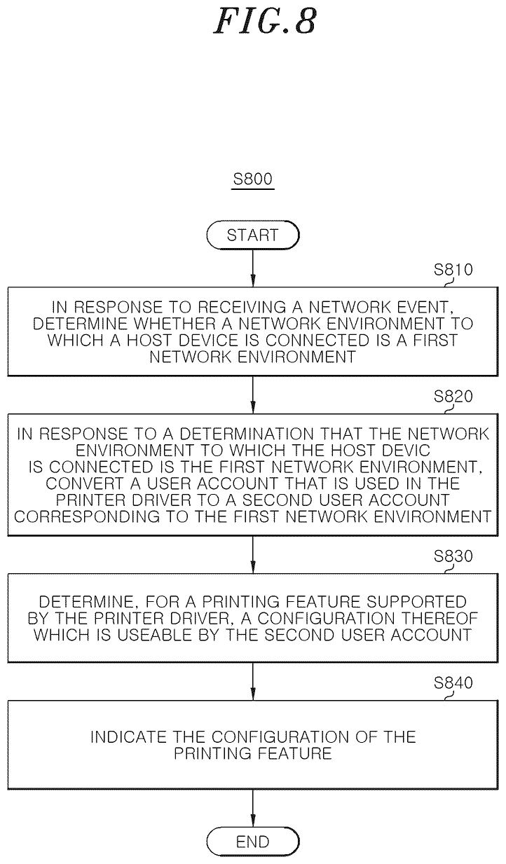

FIG. 8 is an example flow diagram illustratively showing example operations for converting a user account logged into the example printer driver consistent with the disclosure.

In an example, if there occurs an event related to a network to which the host device 100 is connected, the host device 100, e.g., an event handler thereof (not shown), may receive the network event from an operating system of the host device 100. Such a network event may be caused by a change of the network environment to which the host device 100 is connected, by the user starting up the host device 100 and logging into the operating system of the host device 100, or by other circumstances. In response to receiving the network event, the host device 100 may request and receive, from the operating system, etc., information identifying the network environment to which the host device 100 is currently connected, for example, an address such as a gateway MAC address on the connected network.

The memory 120 of the host device 100 may have stored therein information regarding matching user accounts, each of which is to be used for logging into the printer driver in a respective network environment when the host device is connected thereto. For instance, in a predetermined particular network environment, the printer driver of the host device 100 may be used with a corresponding user account, e.g., the first user account. In a predetermined different network environment, the printer driver may be used with a corresponding other user account, e.g., a second user account. For example, when the user uses the host device at his/her office, the user account that is currently used in the printer driver may be converted to his/her business e-mail account. When the user uses the host device for private purposes at his/her home, the user account that is currently used in the printer driver may be converted as well. To this end, when receiving the network event, the host device 100 may store, in the memory 120, for example, in a network identifier and account information repository (not shown) of the memory 120, the information identifying the network environment to which the host device 100 is currently connected, for example, an address on the connected network, such as a MAC address of a gateway to which the host device is connected. This can be done, for instance, such that the identifying information is matched with the information regarding its corresponding, matching user account for use in logging into the printer driver, for example, an e-mail address/login ID, a connection password, etc. This matching information may be preset by the user or may be automatically set and updated through verification of the user account with which the user is logged into the printer driver in the respective network environment. Other example ways of storing and using a correspondence between a certain network environment and a certain user account are also possible.

The method S800 can include an operation S810 of, in response to receiving a network event, determining whether a network environment to which the host device 100 having installed therein the printer driver is connected is a predetermined network environment, for example, a first network environment. In some examples, if there occurs a network event at the host device 100, for instance, if there is a change of the network environment to which the host device 100 is connected, then the event handler of the host device may receive the network event from the operating system. Such a network event may be caused by a change of the network to which the electronic device is connected, by the user starting up the electronic device and logging into the operating system, or by other circumstances.

In some examples, in order to determine whether the network environment to which the host device is connected is the first network environment, the host device 100 may perform an operation of verifying whether a network identifier of the currently connected network environment is included in a list of network identifiers stored in the network identifier and account information repository (not shown) of the memory 120 of the host device 100.

The method S800 can include an operation S820 of, in response to a determination that the network environment to which the host device is connected is the first network environment, converting a user account that is used in the printer driver to the second user account corresponding to the first network environment. In an example where the printer driver of the host device is in use in association of the first user account, if there occurs a network event indicating that there is a change of the network environment to which the host device is connected, the second user account, which is a matching user account for use in the new network environment, may be acquired based on a network identifier of the new network environment and the network identifiers contained in the network identifier and account information repository of the memory 120. If the acquired user account, e.g., the second user account, is different from the account, e.g., the first user account, that is currently used in the printer driver, then a conversion of the user account for use in the printer driver may be made from the first user account to the second user account. If the first user account is identical to the second user account, then there may not be any additional operation for the conversion.

In some examples, the user account conversion operation S820 may be automatically performed without the user's intervention. In some instances, after a message is output to the interface device 130 to query whether to convert the user account, the operation S820 may be performed in response to reception of a reply to the query.

The method S800 may include an operation S830 of, after the conversion from the first user account to the second user account, determining, for a printing feature supported by the printer driver, its configuration which is useable by the second user account. The operation S830 may be the same as that described with respect to FIGS. 4 and 5. Thus, for details thereof, refer to the relevant portions provided above, which will not be repeated here.

The method S800 can include an operation S840 of indicating, on the user interface device 130 of the host device 100, the configuration(s) of the acquired printing feature(s). The operation S840 may be identical to that described with respect to FIGS. 4 and 5. Thus, for details thereof, refer to the relevant portions provided above, which will not be repeated here.

The above-discussed operations of automatically selecting a login account may help the user in reducing inconvenience of manually changing the login account according to a change of the network environment and may also enable using a printing feature of the printer driver in a manner specific to the user's desired account, thereby increasing user convenience. For example, as the user uses his/her laptop at his/her office and then at his/her home, the aforementioned operations may involve configuring the printer driver to be used with a business account for use in a corporate network within the office and then with a personal account for use in a network within the home.

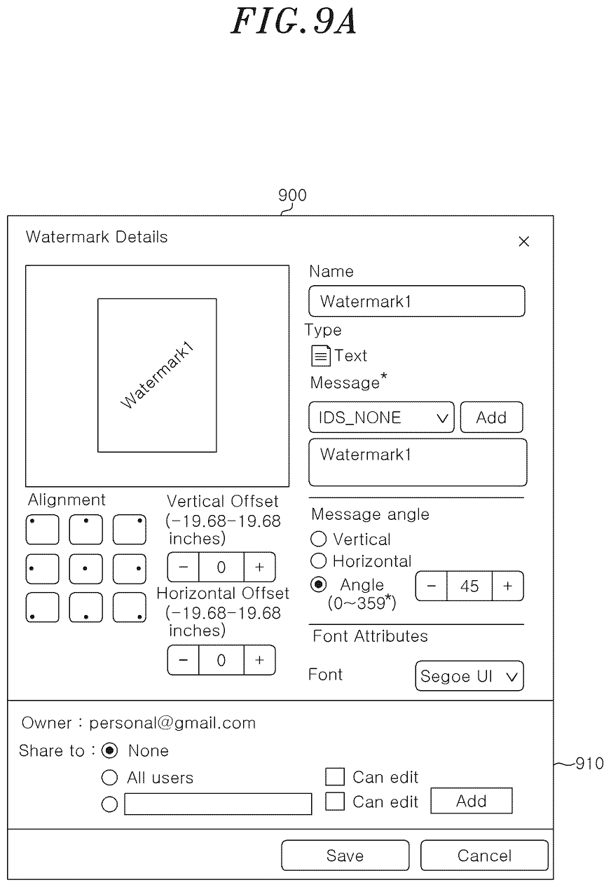

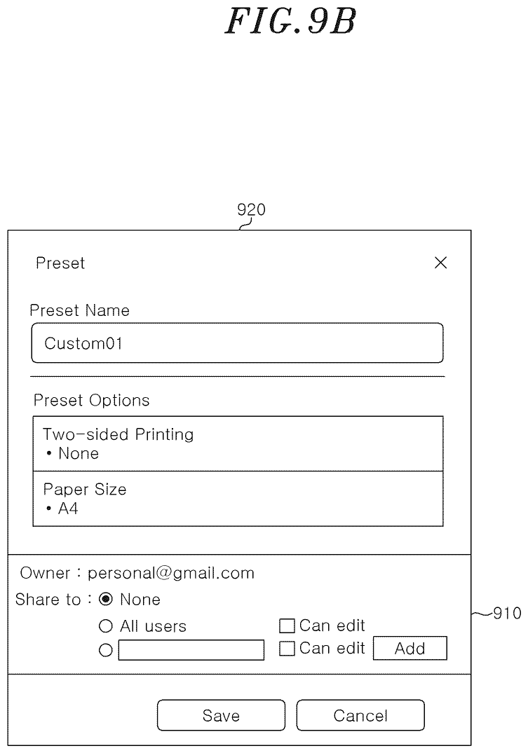

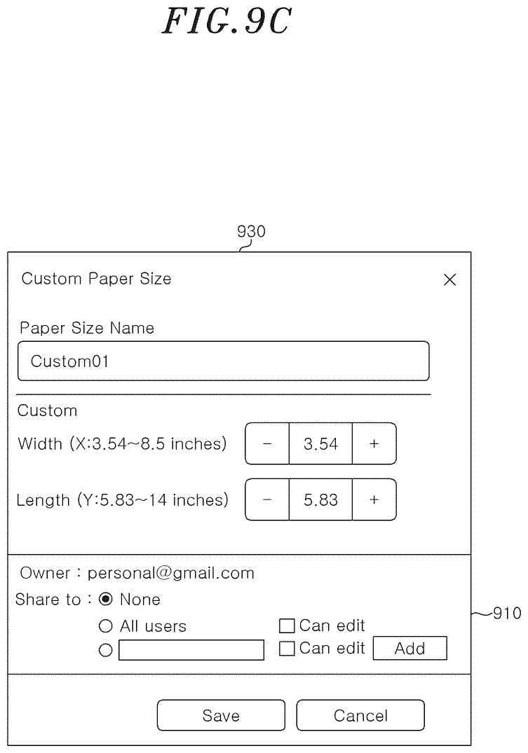

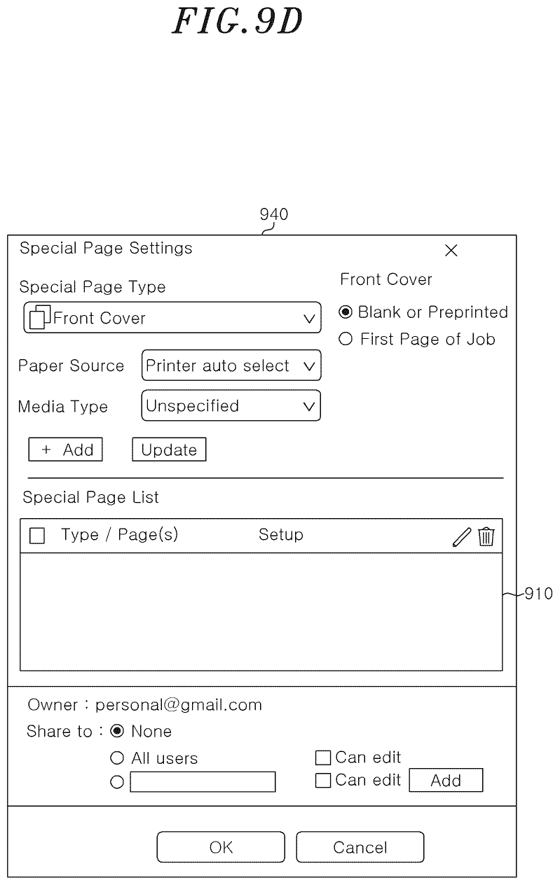

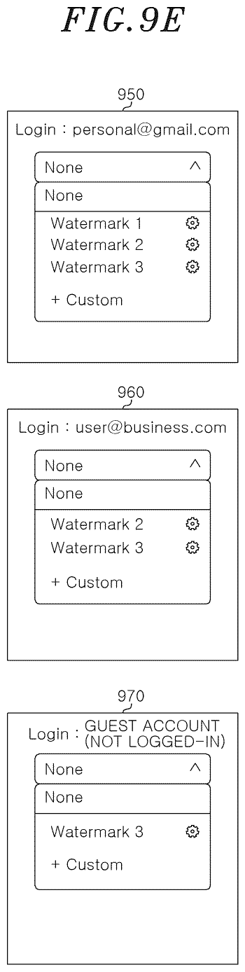

FIGS. 9A to 9E show example interfaces 900, 920, 930, 940, 950, 960, 970, for example printing features supported by the example printer driver and customization of configurations thereof consistent with the disclosure.

In FIG. 9A, there is shown an example interface 900 through which to customize a configuration of a watermark feature supported by the printer driver. The user may create and employ a configuration of the watermark feature by entering details such as setting values of the watermark feature to be applied to printing with the image forming apparatus. In some examples, for the creation and utilization of the configuration of the watermark feature, values may be entered indicating: an identifying name of the configuration, e.g., Watermark1; what type of watermark is to be used, e.g., a text-type watermark, or an image-type watermark; a message to be indicated on the watermark; an arrangement of the watermark; its horizontal and vertical offsets; an angle at which the message is indicated; a font to be applied therefor; etc. In other examples, different implementations of the values to be entered for use of the watermark feature are possible.

In the example of FIG. 9A, the interface 900 includes an interface 910 through which to set another user account's permission to share the to-be-generated configuration of the watermark feature. In the example of FIG. 9A, the indicated user account “personal@gmail.com” is generating the configuration of the watermark feature and is specified as an owner of the configuration. As shown, through the interface 910, the owner may share the generated configuration of the watermark feature with a particular user account, with all user accounts, or with none of the user accounts. Further, with the configuration shared, the owner may determine whether to grant a read/write permission therefor by, for example, selecting the “Can edit” button on the interface 910, or a read-only permission therefor by, for example, not selecting the “Can edit” button on the interface 910.

In FIG. 9B, there is shown an interface 920 through which to customize a configuration of the preset printing option feature supported by the printer driver. The user may create and employ a configuration of the preset printing option feature by entering details such as setting values of the watermark feature to be applied to printing with the image forming apparatus. In some examples, for the creation and utilization of the configuration of the preset printing option feature, values may be entered indicating: an identifying name of the configuration, e.g., Custom01; a configurable printing option, e.g., whether double-sided printing is to be performed, a printing paper size; etc. In other examples, different implementations of the values to be entered for use of the preset printing option feature are possible.

In a manner similar to the example of FIG. 9A, FIG. 9B shows that the interface 920 includes an interface 910 through which to set another user account's permission to share the to-be-generated configuration of the preset printing option feature.

In FIG. 9C, there is shown an interface 930 through which to customize a configuration of the custom paper size feature supported by the printer driver. As can be seen from the interface 930, the user may create and employ a configuration of the custom paper size feature by entering details such as setting values of the custom paper size feature to be applied to printing via the image forming apparatus. In an example, for the creation and utilization of the configuration of the custom paper size feature, values may be entered indicating an identifying name of the configuration, e.g., Custom01, a width and a height of a paper sheet for customization, etc.. In other examples, different implementations of the values to be entered for use of the custom paper size feature are possible.

In a manner similar to the example of FIG. 9A, FIG. 9C shows that the interface 930 includes an interface 910 through which to set another user account's permission to share the to-be-generated configuration of the custom paper size feature.

In FIG. 9D, there is shown an interface 940 through which to customize a configuration of the special page feature supported by the printer driver. As can be seen from the interface 940, the user may create and employ a configuration of the special page feature by entering details such as setting values of the special page feature so as to be applied to printing via the image forming apparatus. In an example, for the creation and utilization of the configuration of the preset printing option feature, values may be entered indicating: an identifying name of the configuration; what type of special page is to be used, e.g., a front cover type or a particular page type; which paper source is to be used; what type of paper sheet is to be used; etc. In other examples, different implementations of the values to be entered for use of the special page feature are possible.

In a manner similar to the example of FIG. 9A, FIG. 9D shows that the interface 940 includes an interface 910 through which to set another user account's permission to share the to-be-generated configuration of the special page feature.

FIG. 9E shows example interfaces 950, 960, 970, each of which indicates configurations of a printing feature that are applicable to a respective user account with which the printer driver is logged into.

It is assumed that the watermark feature is the printing feature to be used in the example of FIG. 9E. As shown, there appears on an interface 950 three configurations, e.g., Watermark 1, Watermark 2, and Watermark 3, useable by the user account “personal@gmail.com” with which the printer driver is logged into. Unlike the above example where the user account “personal@gmail.com” is used, there appears on an interface 960 two configurations, e.g., Watermark 2 and Watermark 3, useable by the user account “user@business.com” with which the printer driver is logged into. For each of the user accounts, a different configuration may be used. Further, unlike the above two examples, there appears on an interface 970 a configuration, e.g., Watermark 3, useable by the guest account with which the printer driver is used.

The user interfaces of the printer driver, each of which has indicated thereon certain information, may be used in various different manners without departing from the spirit of the present disclosure.

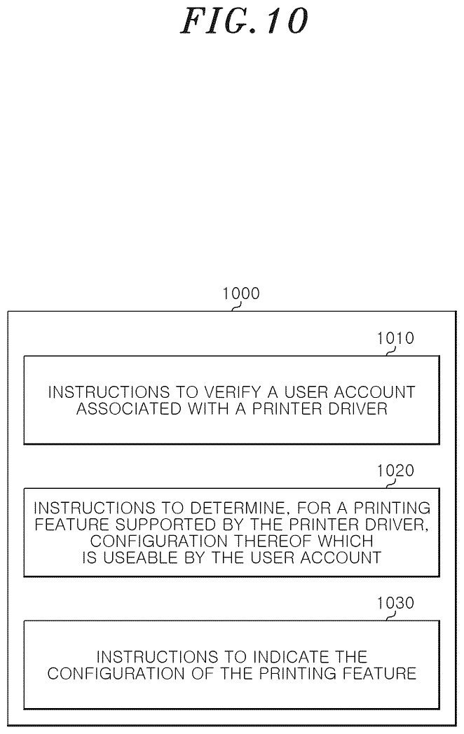

FIG. 10 is a schematic illustration of a computer readable recording medium 1000 including example instructions consistent with the disclosure.

A computer readable recording medium 1000 can store a computer program that is executable by a processor and programmable to implement some operations of the aforementioned methodology, such as the operations of the host device described above with respect to FIGS. 1 to 9 and elements of the method described above with respect to FIGS. 1 to 9.

The computer program on the computer readable recoding medium 1000 may include a set of program instructions 1010, 1020, 1030 that direct the processor to perform specific operations. Now, with reference to FIG. 10, details of the computer program stored in the computer readable recording medium 1000 will be described.

The computer program can instructions 1010, 1020, 1030 that when executed by a computer, cause the computer to perform operations. Specifically, the instructions may include: instructions 1010 to verify a user account associated with a printer driver; instructions 1020 to determine, for a printing feature supported by the printer driver, a configuration thereof which is useable by the user account; and instructions 1030 to indicate the configuration of the printing feature. The computer may include the host device.

Upon execution of the computer program stored in the computer readable recording medium 1000, the instructions 1010, 1020, and 1030 illustrated in FIG. 10, as well as the operations or the methods described above with respect to FIGS. 1 to 9, may be performed by the computer, for example, the above-described host device 100. For further details thereon, reference should be made to the above description.

The above-described computer readable recording medium may be a non-transitory readable medium. The term “non-transitory readable medium” as used herein refers to a medium that is capable of semi-permanently storing data and is readable by an apparatus, rather than a medium, e.g., a register, a cache, a volatile memory device, etc., that temporarily stores data. For example, the foregoing program instructions may be stored and provided in a CD, a DVD, a hard disk, a Blu-ray disc, a USB, a memory card, a ROM device, or any of other types of non-transitory readable media.

In a particular example, the methodology disclosed herein may be incorporated into a computer program product. The computer program product may be available as a product for trading between a seller and a buyer. The computer program product may be distributed in the form of a machine-readable storage medium, e.g., compact disc read-only memory (CD-ROM), or distributed online through an application store, e.g., PlayStore™. For the online distribution, a portion of the computer program product may be temporarily stored, or temporarily created, in a storage medium such as a memory of a server of the manufacturer, a server of the application store, or a relay server, among others. The on-line distribution may be performed in various different manners.

The foregoing description has been presented to illustrate and describe some examples in detail. Modifications and variations are possible in light of the above description. In some examples, suitable results may be achieved if the above-described techniques are performed in a different order, and/or if some of the components of the above-described systems, architectures, devices, circuits, etc. are coupled or combined in a different manner or substituted for or replaced by other components or equivalents thereof.

Therefore, the scope of the present disclosure is not to be limited to the precise form disclosed, but rather defined by the following claims and equivalents thereof.

What is claimed is:

1. A method for user account-specific management of a printer driver, comprising:
verifying a first user account associated with a printer driver installed in a host device;
determining, for a printing feature supported by the printer driver, a configuration thereof useable by the first user account; and
indicating, on a user interface device of the host device, the configuration of the printing feature, wherein:
the printer driver has a plurality of user accounts associable therewith comprising the first user account; and
configurations of the printing feature supported by the printer driver are customizable for each of the plurality of user accounts.

2. The method of claim 1, wherein each of the plurality of user accounts is used for logging into the printer driver.

3. The method of claim 1, further comprising:
in response to reception of a request for generation of a new configuration of the printing feature, generating the new configuration; and
associating, with the first user account, the new configuration to be useable by the first user account.

4. The method of claim 1, wherein:
the plurality of user accounts comprises a guest account with which to use the printer driver without the guest account staying logged into the printer driver;
the guest account uses a common configuration of the printing feature; and
using, among configurations that are customized for each of the plurality of user accounts, a configuration for which the guest account is granted an access permission.

5. The method of claim 3, wherein:
the request comprises data that specifies another user account's permission to access the new configuration; and
permitting, based on the data comprised in the request, the another user account to access the new configuration of the printing feature.

6. The method of claim 1, wherein determining the configuration useable by the first user account comprises reading, from a memory of the host device in which the printer driver is installed, configurations of the printing feature stored therein in association with the first user account.

7. The method of claim 1, wherein the printing feature comprises at least one of: a watermark feature, a preset printing option feature, a custom paper size feature, or a special page feature.

8. The method of claim 1, further comprising:
in response to receiving a network event, determining whether a network environment connected to the host device is a first network environment;
in response to a determination that the network environment connected to the host device is the first network environment, converting a user account that is used in the printer driver from the first user account to a second user account that corresponds to the first network environment;
determining, for a printing feature supported by the printer driver, a configuration thereof useable by the second user account; and
indicating, on the user interface device of the host device, the configuration useable by the second user account.

9. A non-transitory computer readable recording medium having stored therein a computer program executed by a processor of a host device, the processor to:
verify a first user account associated with a printer driver installed in the host device;
determine, for a printing feature supported by the printer driver, a configuration useable by the first user account; and
indicate, on a user interface device of the host device, the configuration of the printing feature, wherein:
the printer driver has a plurality of user accounts associable therewith comprising the first user account; and
configurations of the printing feature supported by the printer driver are customizable for each of the plurality of user accounts.

10. The non-transitory computer readable recording medium of claim 9, wherein each of the plurality of user accounts is used to log into the printer driver.

11. The non-transitory computer readable recording medium of claim 9, wherein the processor is further to:
in response to reception of a request for generation of a new configuration of the printing feature, generate the new configuration; and
associate, with the first user account, the new configuration to be useable by the first user account.

12. The non-transitory computer readable recording medium of claim 9, wherein:
the plurality of user accounts comprises a guest account with which to use the printer driver without the guest account staying logged into the printer driver;
the guest account uses a common configuration of the printing feature; and
using, among configurations that are customized for each of the plurality of user accounts, a configuration for which the guest account is granted an access permission.

13. The non-transitory computer readable recording medium of claim 9, wherein the processor is further to:
in response to receiving a network event, determine whether a network environment to which the host device is connected is a first network environment;
in response to a determination that the network environment to which the host device is connected is the first network environment, convert a user account that is used in the printer driver from the first user account to a second user account that corresponds to the first network environment;
determine, for a printing feature supported by the printer driver, a configuration thereof useable by the second user account; and
indicate, on the user interface device of the host device, the configuration which is useable by the second user account.

14. A host device, comprising:
a processor;
a memory to store instructions; and
a user interface device, wherein when executed, the instructions cause the processor to:
verify a first user account associated with a printer driver installed in the host device;
determine, for a printing feature supported by the printer driver, a configuration thereof useable by the first user account; and
indicate, on the user interface device of the host device, the configuration of the printing feature, wherein:
the printer driver has a plurality of user accounts associable therewith comprising the first user account;
configurations of the printing feature supported by the printer driver are customizable for each of the plurality of user accounts; and
each of the plurality of user accounts is used to log into the printer driver.

15. The host device of claim 14, wherein when executed, the instructions further cause the processor to:
in response to receiving a network event, determine whether a network environment to which the host device is connected is a first network environment;
in response to a determination that the network environment to which the host device is connected is the first network environment, convert a user account that is used in the printer driver from the first user account to a second user account that corresponds to the first network environment;
determine, for a printing feature supported by the printer driver, a configuration thereof useable by the second user account; and
indicate, on the user interface device of the host device, the configuration which is useable by the second user account.
